(19) United States
(12) Patent Application Publication
(10) Pub. No.: US 2018/0241887 A1
(43) Pub. Date: Aug. 23, 2018

(54) INFORMATION PROCESSING DEVICE AND NON-TRANSITORY COMPUTER READABLE MEDIUM

(71) Applicant: FUJI XEROX CO., LTD., Tokyo (JP)

(72) Inventor: Shoji YAMAGUCHI, Kanagawa (JP)

(73) Assignee: FUJI XEROX CO., LTD., Tokyo (JP)

(21) Appl. No.: 15/782,417

(22) Filed: Oct. 12, 2017

(30) Foreign Application Priority Data
Feb. 23, 2017 (JP) 2017-031903

(51) Int. Cl. H04N 1/00; G06F 3/12; G06F 11/22

(52) U.S. Cl. CPC H04N 1/00029; G06F 3/12; H04N 1/00037; G06F 11/2236; H04N 1/00074

(57) ABSTRACT

An information processing device includes an acquisition unit and a display. The acquisition unit acquires, via a communication line, data of an operating state of an apparatus or a device in accordance with a timing associated with an attribute of the data. The display predicts, based on the data, a state of the apparatus or the device for individual attributes, and displays a request for a visit.

### CROSS-REFERENCE TO RELATED APPLICATIONS

This application is based on and claims priority under 35 USC 119 from Japanese Patent Application No. 2017-031903 filed Feb. 23, 2017.

### BACKGROUND

### Technical Field

The present invention relates to an information processing device and a non-transitory computer readable medium.

### SUMMARY

According to an aspect of the invention, there is provided an information processing device including an acquisition unit and a display. The acquisition unit acquires, via a communication line, data of an operating state of an apparatus or a device in accordance with a timing associated with an attribute of the data. The display predicts, based on the data, a state of the apparatus or the device for individual attributes, and displays a request for a visit.

### BRIEF DESCRIPTION OF THE DRAWINGS

Exemplary embodiments of the present invention will be described in detail based on the following figures, wherein:

FIG. 1 is a conceptual module configuration diagram illustrating an example of a configuration according to an exemplary embodiment;

FIG. 2 is an explanatory diagram illustrating an example of a system configuration according to an exemplary embodiment;

FIG. 3 is a flowchart illustrating an example of a process according to an exemplary embodiment;

FIG. 4 is an explanatory diagram illustrating an example of a data structure of an attribute and acquisition timing correspondence table;

FIG. 5 is an explanatory diagram illustrating an example of a data structure of a toner data attribute parameter table;

FIG. 6 is an explanatory diagram illustrating an example of a data structure of a photoreceptor data attribute parameter table;

FIG. 7 is an explanatory diagram illustrating an example of a data structure of a fault prediction data attribute parameter table;

FIG. 8 is an explanatory diagram illustrating an example of a data structure of a parameter and acquisition timing correspondence table;

FIG. 9 is an explanatory diagram illustrating an example of a data structure of a parameter and acquisition timing correspondence table;

FIG. 10 is an explanatory diagram illustrating an example of a data structure of a data acquisition timing rule table;

FIG. 11 is a flowchart illustrating an example of a process according to an exemplary embodiment; and

FIG. 12 is a block diagram illustrating an example of a hardware configuration of a computer according to an exemplary embodiment.

### DETAILED DESCRIPTION

Exemplary embodiments of the present invention will be described below with reference to drawings.

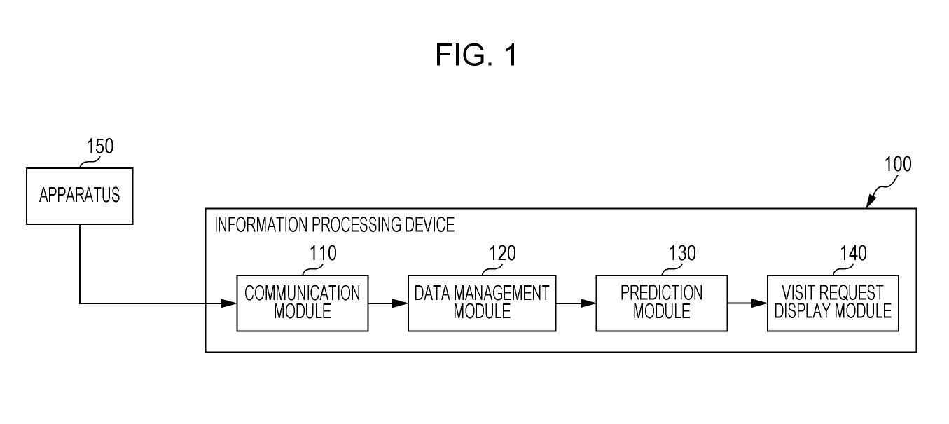

FIG. 1 is a conceptual module configuration diagram illustrating an example of a configuration according to an exemplary embodiment.

In general, the term “module” refers to a component such as software (a computer program), hardware, or the like, which may be logically separated. Therefore, a module in an exemplary embodiment refers not only to a module in a computer program but also to a module in a hardware configuration. Accordingly, through exemplary embodiments, a computer program for causing the component to function as a module (a program for causing a computer to perform each step, a program for causing a computer to function as each unit, and a program for causing a computer to perform each function), a system, and a method are described. For convenience of explanation, the terms “store”, “cause something to store”, and other equivalent expressions will be used. When an exemplary embodiment relates to a computer program, the terms and expressions represent “causing a storing device to store” or “controlling a storing device to store”. A module and a function may be associated on a one-to-one basis. In the actual implementation, however, one module may be implemented by one program, multiple modules may be implemented by one program, or one module may be implemented by multiple programs. Furthermore, multiple modules may be executed by one computer, or one module may be executed by multiple computers in a distributed computer environment or a parallel computer environment. Moreover, a module may include another module. In addition, hereinafter, the term “connection” may refer to logical connection (such as data transfer, instruction, and cross-reference relationship between data) as well as physical connection. The term “being predetermined” represents being set prior to target processing being performed. “Being predetermined” represents not only being set prior to processing in an exemplary embodiment but also being set even after the processing in the exemplary embodiment has started, in accordance with the condition and state at that time or in accordance with the condition and state during a period up to that time, as long as being set prior to the target processing being performed. When there are plural “predetermined values”, the values may be different from one another, or two or more values (obviously, including all the values) may be the same. The term “in the case of A, B is performed” represents “a determination as to whether it is A or not is performed, and when it is determined to be A, B is performed”, unless the determination of whether it is A or not is not required.

Moreover, a “system” or a “device” may be implemented not only by multiple computers, hardware, devices, or the like connected through a communication unit such as a network (including one-to-one communication connection), but also by a single computer, hardware, device, or the like. The terms “device” and “system” are used as synonymous terms. Obviously, the term “system” does not include social “mechanisms” (social system), which are only artificially arranged.

Furthermore, for each process in a module or for individual processes in a module performing plural processes, target information is read from a storing device and a processing result is written to the storing device after the process is performed. Therefore, the description of reading from the storing device before the process is performed or the description of writing to the storing device after the process is performed may be omitted. The storing device may be a hard disk (HD), a random access memory (RAM), an external storage medium, a storing device using a communication line, a register within a central processing unit (CPU), or the like.

An information processing device 100 according to an exemplary embodiment acquires (including collects) data of an operating state of an apparatus or device, predicts the state of the apparatus or device, and displays a request for a visit for replenishment of consumables, repair, and the like. As illustrated in the example of FIG. 1, the information processing device 100 includes a communication module 110, a data management module 120, a prediction module 130, and a visit request display module 140.

A target “apparatus or device” may be, for example, a copying machine, a facsimile machine, a scanner, a printer, a multifunction apparatus (an image processing apparatus having functions of two or more of a scanner, a printer, a copying machine, a facsimile machine, and the like), a time stamp, or the like, which is an image processing apparatus installed in an office. Furthermore, the “apparatus or device” may be an information household apparatus, a robot, a ticket vending machine, an elevator, an escalator, or the like. Hereinafter, an image processing apparatus will be explained as an example.

For example, the information processing device 100 acquires data of an operating state from multiple image processing apparatus, and processes and analyzes the data. Thus, the information processing device 100 is able to predict the life of consumables and predict a fault of the image processing apparatus.

In the case where an exemplary embodiment is not adopted (in a known technology), data to be collected are acquired and processed periodically (for example, once a day or the like). Due to an increase in the number of items to be predicted, the number of apparatuses installed in a market, or the like, load may be applied to a communication line.

Thus, in the information processing device 100 according to an exemplary embodiment, attributes are assigned to data acquired from an operating apparatus or device, and a data acquisition timing is set for each attribute. Accordingly, a degradation of quality such as a reduction in the speed of a communication line may be prevented. Furthermore, data necessary for each item to be predicted may be acquired at an effective timing, and the prediction accuracy may thus be increased.

An apparatus 150 is connected to the communication module 110 of the information processing device 100 via a communication line. The apparatus 150, as a target for the information processing device 100, may be, for example, an image processing apparatus or the like, as described above.

The apparatus 150 transmits data of its own operating state to the information processing device 100. After a transmission request is received from the information processing device 100, the apparatus 150 may transmit data of its own operating state to the information processing device 100. Alternatively, the apparatus 150 may autonomously transmit data of its own operating state to the information processing device 100. In the latter case, the timing of transmission may be specified in advance by the information processing device 100.

Furthermore, for example, attributes to be transmitted from the apparatus 150 to the information processing device 100 may be one or more of operating data regarding toner, a photoreceptor, and a fixing device of an image processing apparatus, and the like.

In addition, data regarding elements forming an image processing apparatus other than the toner, the photoreceptor, and the fixing device may also be used as operating data. For example, operating data regarding a charging device, a cleaning device, a transfer device, an exposure device, a control circuit, and the like may also be used.

The communication module 110 is connected to the data management module 120 and the apparatus 150. The communication module 110 performs communication with the apparatus 150. That is, the communication module 110 acquires, via the communication line, data of the operating state of the apparatus 150, in accordance with a timing associated with an attribute of the data. In general, plural apparatuses 150 are connected to the communication module 110. However, only one apparatus 150 may be connected to the communication module 110.

The data management module 120 is connected to the communication module 110 and the prediction module 130. The data management module 120 manages data acquired by the communication module 110. For example, the data management module 120 manages a fault occurrence state and the like of the apparatus 150.

The data management module 120 may change the timing at which the communication module 110 acquires data, in accordance with the amount of variations in data required for prediction.

Furthermore, the data management module 120 may change the timing for each data item.

Moreover, in the case where there is a change in the communication quality of the communication line or the accuracy of prediction, the data management module 120 may change the timing at which the communication module 110 acquires data.

The prediction module 130 is connected to the data management module 120 and the visit request display module 140. The prediction module 130 predicts the state of the apparatus 150 for each attribute, based on data acquired by the communication module 110. The prediction includes prediction of the life of consumables, prediction of a fault of the apparatus, and the like. Known techniques may be used for prediction. For example, a threshold may be set based on statistics of past operating data (an average, a mode, a median, etc.), so that prediction of the life of consumables, a fault of the apparatus 150, and the like may be performed in accordance with comparison with the threshold. Furthermore, a model may be established using machine learning using teacher data in which past operating data and results (the life of consumables, a fault of the apparatus 150, and the like) are associated with each other, so that prediction may be performed using the model.

For example, the prediction module 130 measures a fault occurrence time interval, based on data from the data management module 120. Furthermore, a threshold of the number of times a fault has occurred or the like, which is a criterion for a maintenance visit, is provided, and the fault occurrence time interval or the like is compared with the threshold. If the fault occurrence time interval is equal to or more than the threshold, it is determined that a request for a visit is to be prompted.

The visit request display module 140 is connected to the prediction module 130. The visit request display module 140 provides display of a visit request to a person in charge of repair, based on prediction results by the prediction module 130. For example, displaying the request may include outputting a three-dimensional (3D) image as well as displaying the request on a display such as a liquid crystal display. Furthermore, displaying the request may be a combination of printing by a printer, outputting sound by an audio output device such as a speaker, vibrations, and the like.

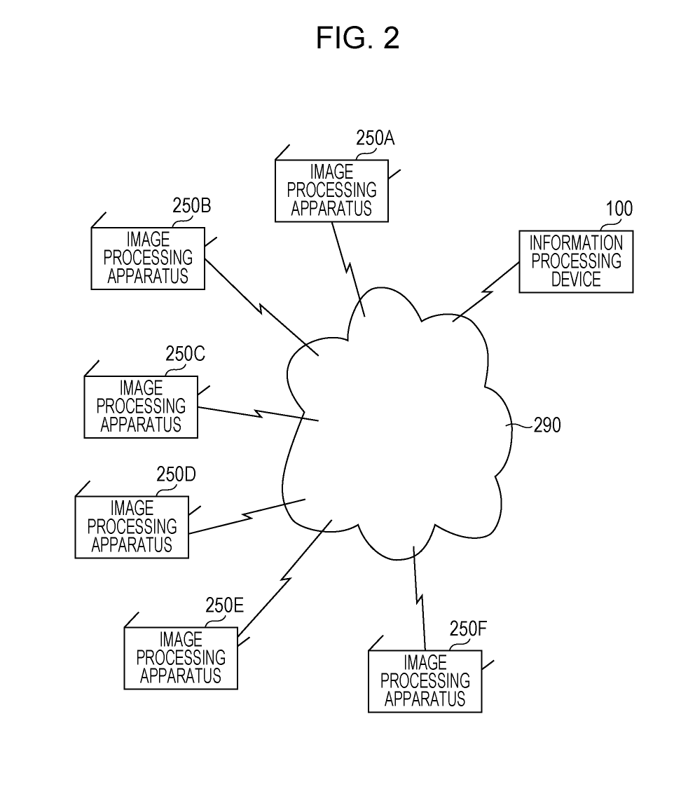

FIG. 2 is an explanatory diagram illustrating an example of a system configuration according to an exemplary embodiment.

The information processing device 100, an image processing apparatus 250A, an image processing apparatus 250B, an image processing apparatus 250C, an image processing apparatus 250D, an image processing apparatus 250E, and an image processing apparatus 250F, which are the apparatus 150, are connected to one another via a communication line 290. The communication line 290 may be wireless, wired, or a combination of wired and wireless. The communication line 290 may be, for example, the Internet, an intranet, or the like as a communication infrastructure. Furthermore, functions of the information processing device 100 may be implemented as a cloud service. The information processing device 100 manages, for example, occurrence of an error (fault) and the like.

For example, the image processing apparatus 250 is installed at a store such as a convenience store, and staff of a company that manages the image processing apparatus 250 uses the information processing device 100.

The information processing device 100 acquires operating data from the image processing apparatus 250. For example, the information processing device 100 acquires operating data required for prediction of the life of consumables in the image processing apparatus 250, operating data required for prediction of the replacement time for a replacement part or the like, and operating data required for prediction of a fault such as a paper jam. The information processing device 100 also assigns attributes to individual data items required for prediction and categorizes the attributes according to a prediction item. Thus, the information processing device 100 sets a timing at which operating data is acquired from the image processing apparatus 250, in accordance with the attribute of data categorized according to the prediction item. Regarding operating data of consumables, for example, a data acquisition timing such as once a day (or twice a day etc.) is set for operating data regarding the life of toner, which varies relatively greatly on a daily basis. Referring to past data, a period up to the time at which the amount of variations becomes equal to a predetermined value may be set as a period (interval) for data acquisition.

Alternatively, for example, in the case where the life of toner, a photoreceptor, or the like is predicted for each member for which prediction is to be performed, a necessary data acquisition period may be set for each item. Accordingly, a degradation in the quality of the communication network may be prevented while a high prediction accuracy being maintained.

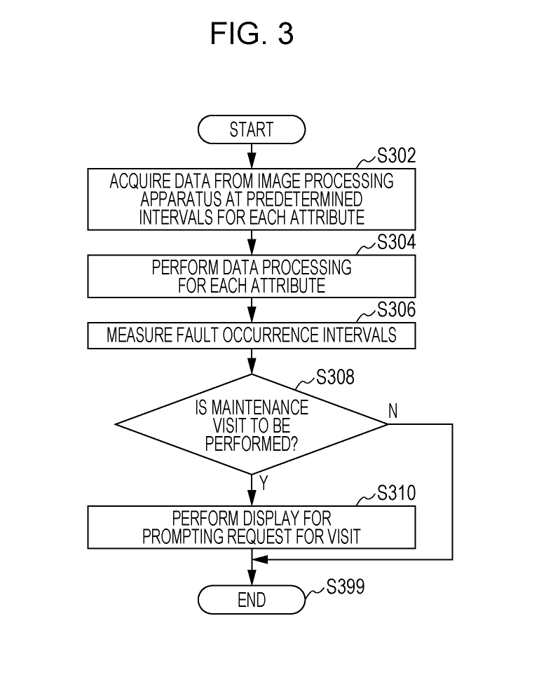

FIG. 3 is a flowchart illustrating an example of a process according to an exemplary embodiment.

In step S302, the communication module 110 acquires operating data from the image processing apparatus 250 at predetermined intervals for each attribute. As described above, the communication module 110 may transmit a transmission request and the image processing apparatus 250 may transmit operating data. Alternatively, the image processing apparatus 250 may autonomously transmit data of its own operating state to the communication module 110. In one communication operation, for example, at least one or more of operating data regarding toner, operating data regarding a photoreceptor, and operating data regarding a fixing device are transmitted. The transmission timing is determined for each attribute. Specifically, operating data regarding toner, operating data regarding a photoreceptor, and operating data regarding a fixing device are transmitted at different timings. Obviously, the transmission timings may overlap.

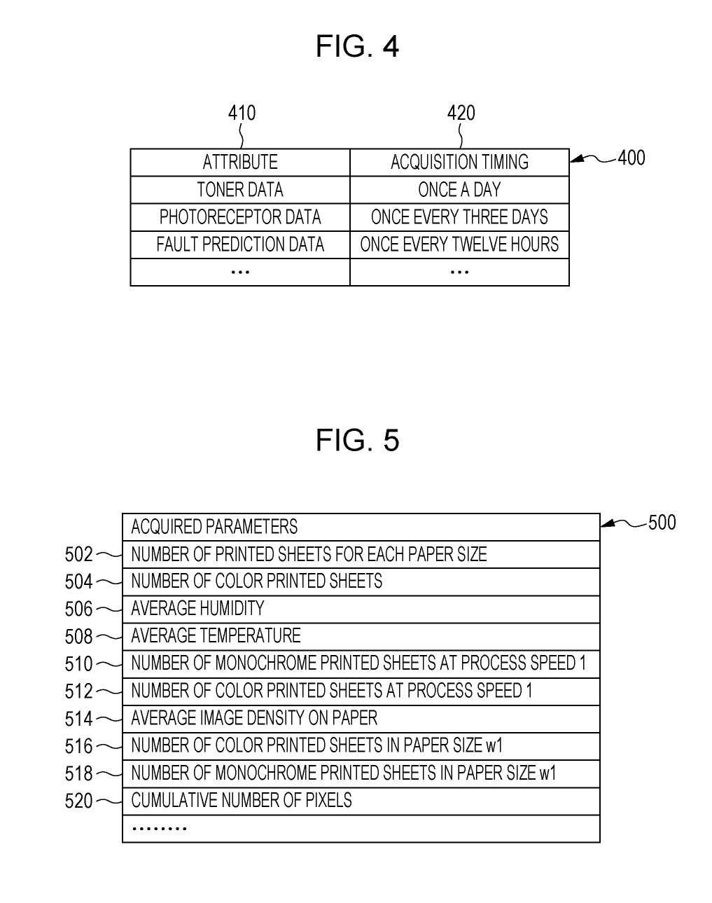

For example, the acquisition timing for operating data is managed by an attribute and acquisition timing correspondence table 400. FIG. 4 is an explanatory diagram illustrating an example of a data structure of the attribute and acquisition timing correspondence table 400. The attribute and acquisition timing correspondence table 400 includes an attribute field 410 and an acquisition timing field 420. The attribute field 410 stores attributes. The acquisition timing field 420 stores acquisition timing. For example, referring to FIG. 4, in the case where the attribute of data is related to toner, the data is acquired once a day. In the case where the attribute of data is related to a photoreceptor, the data is acquired once every three days. In the case where the attribute of data is related to fault prediction, the data is acquired once every twelve hours.

In step S304, the data management module 120 performs data processing for each attribute. For example, the data management module 120 performs data processing for each data item acquired in step S302 (any one of operating data regarding toner of the image processing apparatus 250, operating data regarding a photoreceptor, and operating data regarding a fixing device). Obviously, the type of processing varies according to the type of acquired data. For example, the number of remaining days for toner replenishing is calculated based on operating data regarding toner, the number of remaining days for replacement of a photoreceptor is calculated based on operating data regarding the photoreceptor, and a determination as to whether or not to change a parameter for a fixing device is made based on operating data regarding the fixing device.

In step S306, the prediction module 130 measures fault occurrence intervals. For example, a fault may be a paper jam caused by a paper feeding device. When the current time corresponds to a period during which a fault is highly likely to occur in a component of the target image processing apparatus 250, it is determined that, for example, a maintenance visit is to be performed.

In step S308, the prediction module 130 determines whether or not to perform a maintenance visit. In the case where it is determined that a maintenance visit is to be made, the process proceeds to step S310. In the case where it is not determined that a maintenance visit is to be made, the process ends (step S399). In the case where there is a high possibility that a fault may occur, the case where replacement of a consumable is required, or other cases, the process proceeds to step S310.

In step S310, the visit request display module 140 provides display for prompting a request for a maintenance visit or the like on the target image processing apparatus 250. For example, a user who receives the display for prompting a request for a visit contacts a person in charge of maintenance or the like. Accordingly, a maintenance visit or the like is performed to the image processing apparatus 250.

As illustrated in the example of FIG. 2, the communication module 110 of the information processing device 100 acquires operating data from the installed plural image processing apparatuses 250 via the communication line 290, at predetermined intervals for each attribute. Then, the data management module 120 and the prediction module 130 analyze and process the data acquired for each attribute, so that life prediction and fault prediction may be achieved.

Regarding attributes, attributes are assigned to individual parameters relating to an item to be predicted, for example, the life of a consumable such as toner, and required data acquisition intervals are set for individual attributes. In accordance with this, data acquisition is performed. Thus, the influence of communication quality on the communication line 290 may be reduced, and prediction may be achieved with high accuracy.

Parameters relating to toner as a consumable, a photoreceptor as a consumable, and fault prediction are illustrated in FIGS. 5, 6, and 7, respectively.

FIG. 5 is an explanatory diagram illustrating an example of a data structure of a toner data attribute parameter table 500. The toner data attribute parameter table 500 includes a number of printed sheets for each paper size field 502, a number of color printed sheets field 504, an average humidity field 506, an average temperature field 508, a number of monochrome printed sheets at process speed 1 field 510, a number of color printed sheets at process speed 1 field 512, an average image density on paper field 514, a number of color printed sheets in paper size w1 field 516, a number of monochrome printed sheets in paper size w1 field 518, and a cumulative number of pixels field 520. The number of printed sheets for each paper size field 502 stores the number of printed sheets in each paper size. The number of color printed sheets field 504 stores the number of sheets printed in color. The average humidity field 506 stores an average humidity. The average temperature field 508 stores an average temperature. The number of monochrome printed sheets at process speed 1 field 510 stores the number of sheets printed in black and white at process speed 1. The number of color printed sheets at process speed 1 field 512 stores the number of sheets printed in color at process speed 1. The average image density on paper field 514 stores an average image density on paper. The number of color printed sheets in paper size w1 field 516 stores the number of sheets printed in color in paper size w1. The number of monochrome printed sheets in paper size w1 field 518 stores the number of sheets printed in black and white in paper size w1. The cumulative number of pixels field 520 stores the cumulative number of pixels.

The toner data attribute parameter table 500 illustrated in the example of FIG. 5 represents parameter acquisition data which is related to prediction of the life of toner. The series of parameters are assigned an attribute “toner data”, for example, and only parameter data that are assigned this attribute are acquired at predetermined intervals, such as once a day. The acquisition intervals may be set to, for example, once every three days, once every twelve hours, or the like, according to the operating state.

Specifically, an associated attribute (an attribute indicating operating data which is related to toner) is set for each item in the toner data attribute parameter table 500, and a data acquisition period for each parameter (data indicated in the toner data attribute parameter table 500) is set in accordance with the attribute, using the attribute and acquisition timing correspondence table 400 described above.

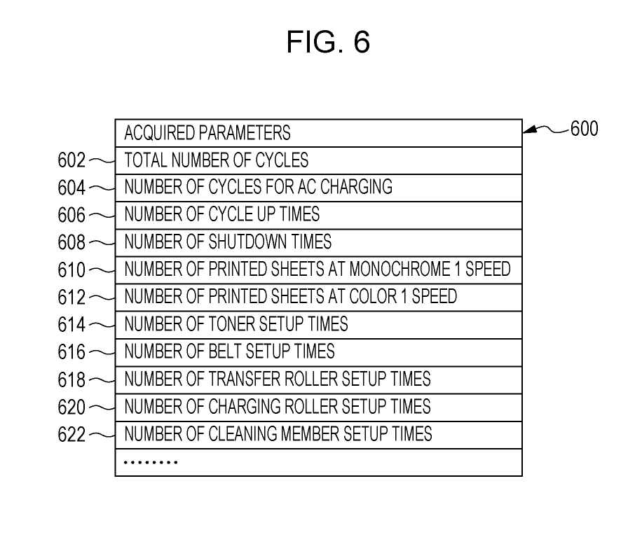

FIG. 6 is an explanatory diagram illustrating an example of a data structure of a photoreceptor data attribute parameter table 600. The photoreceptor data attribute parameter table 600 includes a total number of cycles field 602, a number of cycles for AC charging field 604, a number of cycle up times field 606, a number of shutdown times field 608, a number of printed sheets at monochrome 1 speed field 610, a number of printed sheets at color 1 speed field 612, a number of toner setup times field 614, a number of belt setup times field 616, a number of transfer roller setup times field 618, a number of charging roller setup times field 620, and a number of cleaning member setup times field 622. The total number of cycles field 602 stores the total number of cycles. The number of cycles for AC charging field 604 stores the number of cycles at the time of AC charging. The number of cycle up times field 606 stores the number of cycle up times. The number of shutdown times field 608 stores the number of shutdown times. The number of printed sheets at monochrome 1 speed field 610 stores the number of sheets printed at monochrome 1 speed. The number of printed sheets at color 1 speed field 612 stores the number of sheets printed at color 1 speed. The number of toner setup times field 614 stores the number of times toner is set up. The number of belt setup times field 616 stores the number of times a belt is set up. The number of transfer roller setup times field 618 stores the number of times a transfer roller is set up. The number of charging roller setup times field 620 stores the number of times a charging roller is set up. The number of cleaning member setup times field 622 stores the number of times a cleaning member is set up.

The photoreceptor data attribute parameter table 600 illustrated in the example of FIG. 6 represents parameter acquisition data which is related to prediction of the life of a photoreceptor. The series of parameters are assigned an attribute “photoreceptor data”, for example, and only parameter data that are assigned this attribute are acquired at predetermined intervals, such as once every three days. The acquisition intervals may be set to, for example, once a day, once every twelve hours, or the like, according to the operating state.

Specifically, an associated attribute (an attribute indicating operating data which is related to a photoreceptor) is set for each item in the photoreceptor data attribute parameter table 600, and a data acquisition period for each parameter (data indicated in the photoreceptor data attribute parameter table 600) is set in accordance with the attribute, using the attribute and acquisition timing correspondence table 400 described above.

Obviously, the same data acquisition period as the data acquisition period for parameters related to the attribute “toner data” illustrated in FIG. 5 or a different data acquisition period may be set for each attribute, taking into consideration the operating state, the network communication state, and the like.

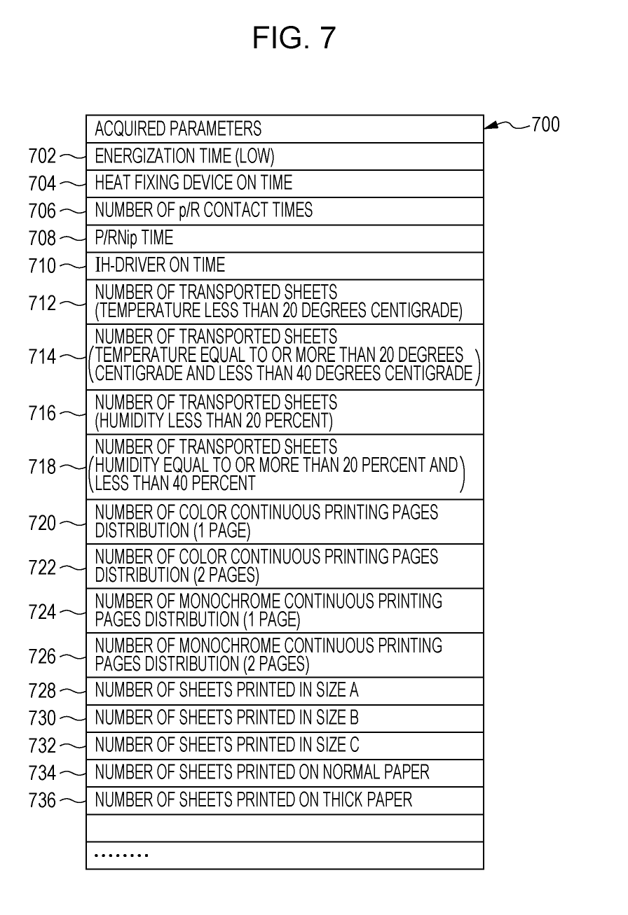

FIG. 7 is an explanatory diagram illustrating an example of a data structure of a fault prediction data attribute parameter table 700. The fault prediction data attribute parameter table 700 includes an energization time (LOW) field 702, a heat fixing device ON time field 704, a number of p/R contact times field 706, a P/RNip time field 708, an IH-DRIVER ON time field 710, a number of transported sheets (temperature less than 20 degrees centigrade) field 712, a number of transported sheets (temperature equal to or more than 20 degrees centigrade and less than 40 degrees centigrade) field 714, a number of transported sheets (humidity less than 20 percent) field 716, a number of transported sheets (humidity equal to or more than 20 percent and less than 40 percent) field 718, a number of color continuous printing pages distribution (1 page) field 720, a number of color continuous printing pages distribution (2 pages) field 722, a number of monochrome continuous printing pages distribution (1 page) field 724, a number of monochrome continuous printing pages distribution (2 pages) field 726, a number of sheets printed in size A field 728, a number of sheets printed in size B field 730, a number of sheets printed in size C field 732, a number of sheets printed on normal paper field 734, and a number of sheets printed on thick paper field 736. The energization time (LOW) field 702 stores an energization time (LOW). The heat fixing device ON time field 704 stores the time during which a heat fixing device is in an ON state. The number of p/R contact times field 706 stores the number of p/R contact times. The P/RNip time field 708 stores a P/RNip time. The IH-DRIVER ON time field 710 stores the time during which an IH-DRIVER is in an ON state. The number of transported sheets (temperature less than 20 degrees centigrade) field 712 stores the number of transported sheets (temperature less than 20 degrees centigrade). The number of transported sheets (temperature equal to or more than 20 degrees centigrade and less than 40 degrees centigrade) field 714 stores the number of transported sheets (temperature equal to or more than 20 degrees centigrade and less than 40 degrees centigrade). The number of transported sheets (humidity less than 20 percent) field 716 stores the number of transported sheets (humidity less than 20 percent). The number of transported sheets (humidity equal to or more than 20 percent and less than 40 percent) field 718 stores the number of transported sheets (humidity equal to or more than 20 percent and less than 40 percent). The number of color continuous printing pages distribution (1 page) field 720 stores distribution of the number of color continuous printing pages (1 page). The number of color continuous printing pages distribution (2 pages) field 722 stores distribution of the number of color continuous printing pages (2 pages). The number of monochrome continuous printing pages distribution (1 page) field 724 stores distribution of the number of monochrome continuous printing pages (1 page). The number of monochrome continuous printing pages distribution (2 pages) field 726 stores distribution of the number of monochrome continuous printing pages (2 pages). The number of sheets printed in size A field 728 stores the number of sheets printed in size A. The number of sheets printed in size B field 730 stores the number of sheets printed in size B. The number of sheets printed in size C field 732 stores the number of sheets printed in size C. The number of sheets printed on normal paper field 734 stores the number of sheets printed on normal paper. The number of sheets printed on thick paper field 736 stores the number of sheets printed on thick paper.

The fault prediction data attribute parameter table 700 illustrated in the example of FIG. 7 represents parameter acquisition data which is related to fault prediction. The series of parameters are assigned an attribute “fault prediction data”, for example, and only parameter data that are assigned this attribute are acquired at predetermined intervals, such as once every twelve hours. The acquisition intervals may be set to, for example, once a day, once every three days, or the like, according to the operating state.

Specifically, an associated attribute (an attribute indicating operating data which is related to fault prediction) is set for each item in the fault prediction data attribute parameter table 700, and a data acquisition period for each parameter (data indicated in the fault prediction data attribute parameter table 700) is set in accordance with the attribute, using the attribute and acquisition timing correspondence table 400 described above.

Obviously, the same data acquisition period as the data acquisition period for parameters related to the attribute “toner data” illustrated in FIG. 5 or the attribute “photoreceptor data” illustrated in FIG. 6 or a different data acquisition period may be set for each attribute, taking into consideration the operating state, the network communication state, and the like.

In the examples illustrated in FIGS. 4 to 7, attributes are assigned to individual items to be predicted, and a data acquisition period is set according to the attribute. A period setting method for a data acquisition period for each attribute will be described below.

An acquisition period is changed according to the variation amount of data. Specifically, the variation amount (threshold) of data to be acquired is set in advance for each parameter, and an acquisition period is set according to a period in which the variation amount of each parameter exceeds the set variation amount (threshold).

For prediction of the life of toner or the like, regarding the variation amount (threshold), a data acquisition period A (set value) for each parameter is set in advance using a value obtained by, for example, dividing the variation amount of data of a parameter by the number of printed sheets during the entire life. Specifically, the variation amount of data per sheet is calculated, and then the variation amount (threshold) is calculated by multiplying the variation amount of data per sheet by the number of sheets at a toner replacement timing or the like. Then, a set value exceeding the variation amount (threshold) may be calculated. Furthermore, in accordance with a desired prediction accuracy, by setting a smaller set value when a high accuracy is required and setting a larger set value when there is a concern about the quality of communication such as a network, a highly accurate acquisition period or an acquisition period which is less likely to affect the communication quality may be set. A set value for data acquisition may be set for each parameter.

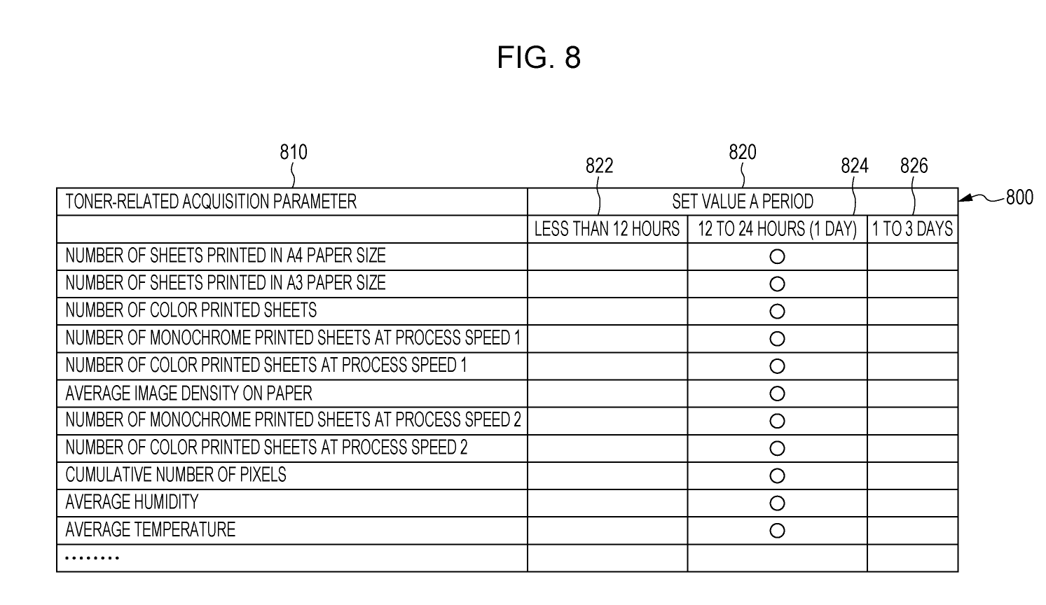

A more specific example will be described with reference to FIG. 8.

A set value A for a parameter: the “number of sheets printed in A4 paper size” is set, using operating data until the current time, such that a value obtained by dividing (the number of printed sheets) by (the number of sheets that may be printed using toner in the apparatus) represents about 1 percent (1 percent is merely an example). For example, let the number of sheets that may be printed using toner in the apparatus be 100,000 and the time to be spent to print up to 1,000 sheets be 24 hours (1 day). In this case, the set value A for the data acquisition period for the number of sheets printed in A4 paper size is set to one day. Furthermore, set values for individual parameters related to consumables (toner and the like) are calculated using operating data until the current time and the like.

Using the calculation result, for example, a parameter and acquisition timing correspondence table 800 is generated as default values. FIG. 8 is an explanatory diagram illustrating an example of a data structure of the parameter and acquisition timing correspondence table 800. The parameter and acquisition timing correspondence table 800 includes a toner-related acquisition parameter field 810 and a set value A period field 820. The set value A period field 820 includes a less than 12 hours field 822, a 12 to 24 hours (1 day) field 824, and a 1 to 3 days field 826. The toner-related acquisition parameter field 810 stores acquired parameters related to toner. The set value A period field 820 stores a period as a set value A. The less than 12 hours field 822 stores a case where the set value A period is less than 12 hours. The 12 to 24 hours (1 day) field 824 stores a case where the set value A period is 12 hours to 24 hours (1 day). The 1 to 3 days field 826 stores a case where the set value A period is 1 day to 3 days.

In the example of FIG. 8, regarding parameters related to toner as consumables, a period during which the variation amount for the attribute “toner data” is equal to the set value A is illustrated. In this example, the acquisition period for the attribute “toner data” is 12 hours to 24 hours (1 day).

Next, a case where the set value A varies will be described.

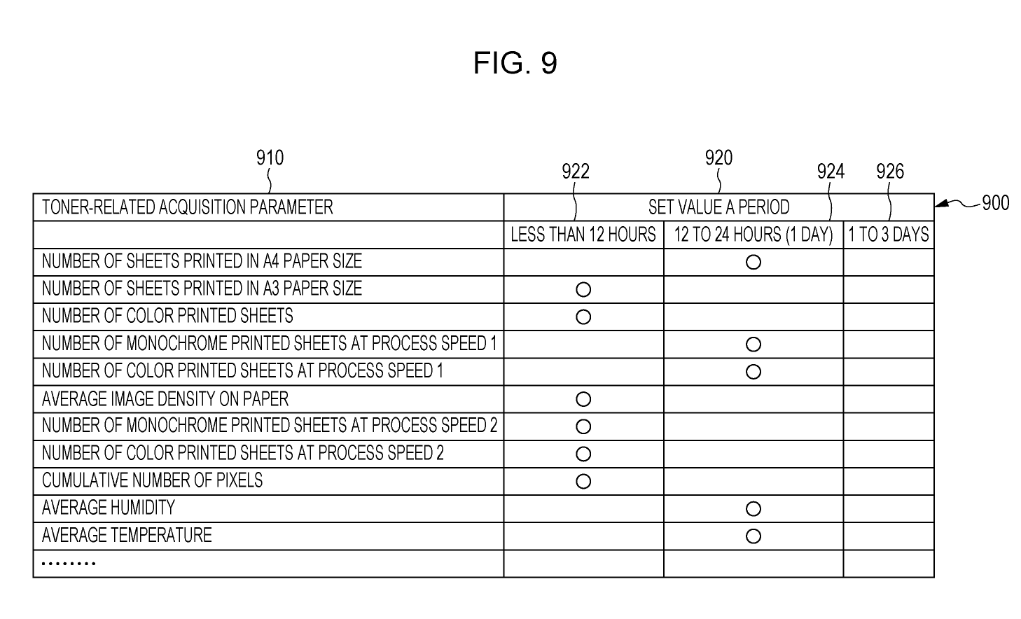

FIG. 9 is an explanatory diagram illustrating an example of a data structure of a parameter and acquisition timing correspondence table 900. The parameter and acquisition timing correspondence table 900 incudes a toner-related acquisition parameter field 910 and a set value A period field 920. The set value A period field 920 includes a less than 12 hours field 922, a 12 to 24 hours (1 day) field 924, and a 1 to 3 days field 926. The parameter and acquisition timing correspondence table 900 has a data structure equivalent to the parameter and acquisition timing correspondence table 800 illustrated in the example of FIG. 8.

As illustrated in the example of FIG. 9, in the case where, regarding a set value A period for each parameter, there is a variation in the set value A period for a parameter, for example, the data acquisition period is set according to the number of items of the parameter or the like. In the case of the example of FIG. 9, the data acquisition period is set to 12 hours. When the parameter and acquisition timing correspondence table 900 is compared with the parameter and acquisition timing correspondence table 800 illustrated in FIG. 8, the set value A period for the “number of sheets printed in A3 paper size”, the “number of color printed sheets”, the “average image density on paper”, the “number of monochrome printed sheets at process speed 2”, the “number of color printed sheets at process speed 2”, the “cumulative number of pixels”, and the like is changed from the 12 to 24 hours (1 day) field 924 to the less than 12 hours field 922.

The data acquisition period may be set and adjusted in an appropriate manner taking into consideration the communication quality of the communication line and prediction accuracy.

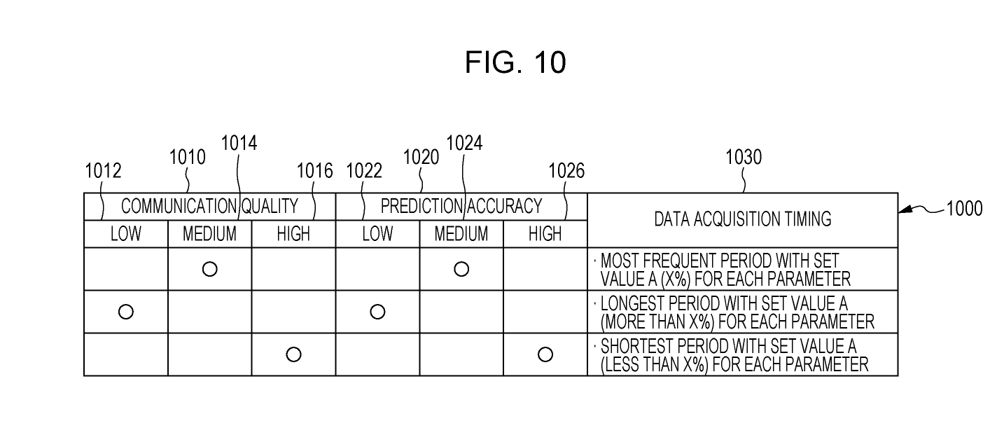

In the case where the data acquisition timing is set taking into consideration the communication quality of the communication line and prediction accuracy, an optimal data acquisition timing is set in accordance with the communication quality and desired prediction accuracy, as illustrated in an example of FIG. 10.

FIG. 10 is an explanatory diagram illustrating an example of a data structure of a data acquisition timing rule table 1000. The data acquisition timing rule table 1000 includes a communication quality field 1010, a prediction accuracy field 1020, and a data acquisition timing field 1030. The communication quality field 1010 includes a low field 1012, a medium field 1014, and a high field 1016, and the prediction accuracy field 1020 includes a low field 1022, a medium field 1024, and a high field 1026. The communication quality field 1010 stores communication quality. The low field 1012 stores a case where the communication quality is “low”. The medium field 1014 stores a case where the communication quality is “medium”. The high field 1016 stores a case where the communication quality is “high”. The prediction accuracy field 1020 stores prediction accuracy. The low field 1022 stores a case where the prediction accuracy is “low”. The medium field 1024 stores a case where the prediction accuracy is “medium”. The high field 1026 stores a case where the prediction accuracy is “high”. The data acquisition timing field 1030 stores data acquisition timing. When the communication quality is low, a longer acquisition period is set so that the communication load is reduced. When the communication quality is high, a shorter acquisition period is set so that the prediction accuracy is increased. Furthermore, in the case where there is a request to reduce the prediction accuracy, a longer acquisition period is set. In the case where there is a request to increase the prediction accuracy, a shorter acquisition period is set.

A change in the communication quality is detected by measuring a communication line (a communication apparatus or the like). Furthermore, a change in the prediction accuracy is performed in accordance with an operation by a user (for example, an administrator of the information processing device 100 or the like).

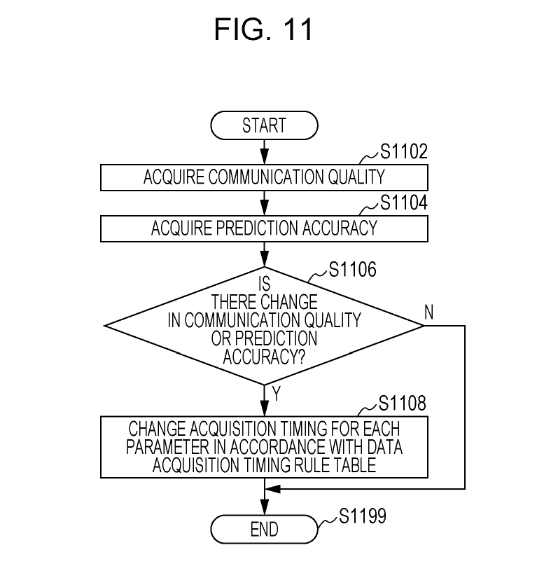

FIG. 11 is a flowchart illustrating an example of a process according to an exemplary embodiment (the prediction module 130).

In step S1102, the current communication quality is acquired.

In step S1104, desired prediction accuracy is acquired.

In step S1106, it is determined whether or not there is a change in the communication quality or the prediction accuracy. In the case where it is determined that there is a change in the communication quality or the prediction accuracy, the process proceeds to step S1108. In the case where it is not determined that there is a change in the communication quality or the prediction accuracy, the process ends (step S1199).

In step S1108, acquisition timing for each parameter is changed in accordance with the data acquisition timing rule table 1000.

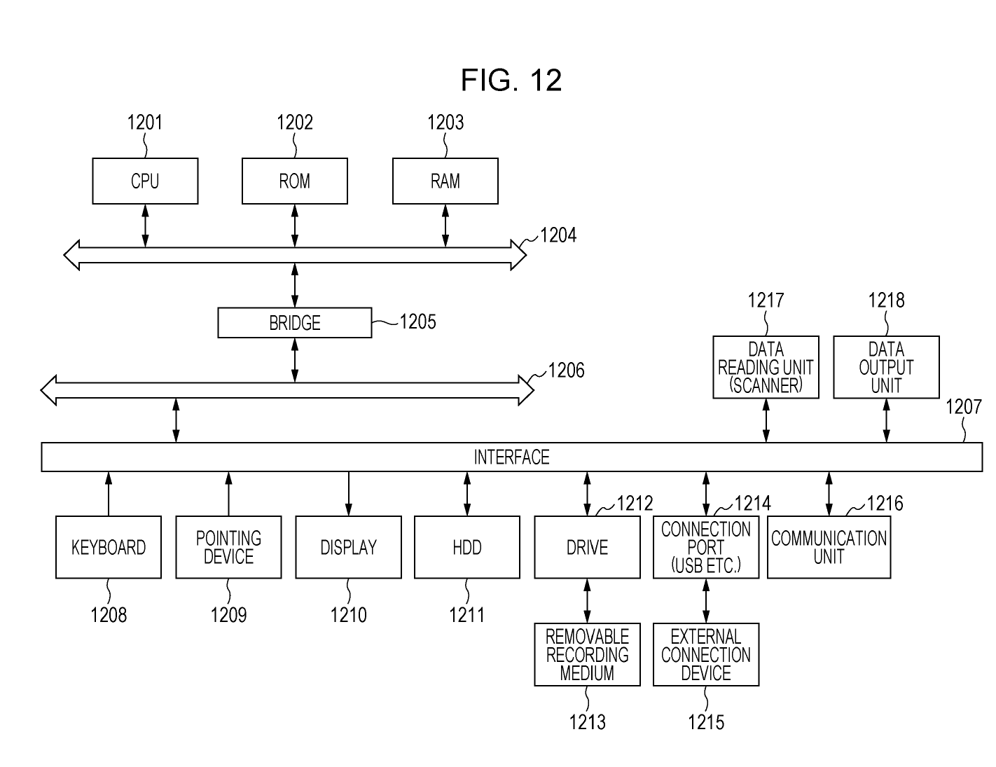

An example of a hardware configuration of an information processing device according to an exemplary embodiment will be described with reference to FIG. 12. The configuration illustrated in FIG. 12 is implemented by, for example, a computer or the like, and an example of a hardware configuration including a data reading unit 1217 such as a scanner and a data output unit 1218 such as a printer is illustrated.

A CPU 1201 is a controller which performs processing in accordance with a computer program in which an execution sequence of the various modules described in the foregoing exemplary embodiment, that is, individual modules including the communication module 110, the data management module 120, the prediction module 130, the visit request display module 140, and the like, is described.

A read only memory (ROM) 1202 stores a program, an arithmetic parameter, and the like to be used by the CPU 1201. A RAM 1203 stores a program to be used in execution of the CPU 1201, a parameter which changes in an appropriate manner in the execution of the program, and the like. These units are connected to one another via a host bus 1204, which is a CPU bus or the like.

The host bus 1204 is connected to an external bus 1206, such as a peripheral component interconnect/interface (PCI) bus, via a bridge 1205.

A keyboard 1208 and a pointing device 1209 such as a mouse are devices to be operated by an operator. A display 1210 may be a liquid crystal display, a cathode ray tube (CRT), or the like, and displays various types of information as text or image information. Furthermore, the display 1210 may be a touch screen or the like including functions of both the pointing device 1209 and the display 1210. In such a case, a function of a keyboard is not necessarily implemented by physical connection, like the keyboard 1208. A function of a keyboard may be implemented by rendering a keyboard by software (may be called a so-called “software keyboard”, “screen keyboard”, or the like) on a screen (touch screen).

A hard disk drive (HDD) 1211 includes therein a hard disk (may be a flash memory or the like). The HDD 1211 drives the hard disk to record or reproduce a program to be executed by the CPU 1201 or information. The hard disk stores the attribute and acquisition timing correspondence table 400, the toner data attribute parameter table 500, the photoreceptor data attribute parameter table 600, the fault prediction data attribute parameter table 700, the parameter and acquisition timing correspondence table 800, the parameter and acquisition timing correspondence table 900, the data acquisition timing rule table 1000, and the like for the operating state of the apparatus 150 or the like received by the communication module 110. Furthermore, various other data, computers, programs, and the like are stored in the hard disk.

A drive 1212 reads data or a program recorded in a removable recording medium 1213 such as a loaded magnetic disk, optical disk, a magneto-optical disk, or semiconductor memory, and supplies the data or program to the connected RAM 1203 via an interface 1207, the external bus 1206, the bridge 1205, and the host bus 1204. A removable recording medium 1213 may also be used as a data recording region.

A connection port 1214 is a port which allows connection with an external connection device 1215, and includes a connection part such as a universal serial bus (USB), IEEE 1394, or the like. The connection port 1214 is connected to the CPU 1201 and the like via the interface 1207, the external bus 1206, the bridge 1205, the host bus 1204, and the like. A communication unit 1216 is connected to a communication line, and performs data communication processing with an external device. The data reading unit 1217 is, for example, a scanner, and performs document reading processing. The data output unit 1218 is, for example, a printer, and performs document data output processing.

The hardware configuration of the information processing device illustrated in FIG. 12 illustrates a configuration example. An exemplary embodiment is not limited to the configuration illustrated in FIG. 12 as long as a configuration which may execute modules explained in the exemplary embodiment is provided. For example, part of the modules may be configured as dedicated hardware (for example, an application specific integrated circuit (ASIC) or the like), part of the modules may be arranged in an external system in such a manner that they are connected via a communication line, or the system illustrated in FIG. 12 which is provided in plural may be connected via a communication line in such a manner that they operate in cooperation. Furthermore, the information processing device 100 may be incorporated in a personal computer or a target apparatus 150 (an information electronic appliance, a robot, a copying machine, a facsimile machine, a scanner, a printer, a multifunction apparatus, or the like).

The programs described above may be stored in a recording medium and provided or may be supplied through communication. In this case, for example, the program described above may be considered as an invention of “a computer-readable recording medium which records a program”.

“A computer-readable recording medium which records a program” represents a computer-readable recording medium which records a program to be used for installation, execution, and distribution of the program.

A recording medium is, for example, a digital versatile disc (DVD), including “a DVD-R, a DVD-RW, a DVD-RAM, etc.”, which are the standards set by a DVD forum, and “a DVD+R, a DVD+RW, etc.”, which are the standards set by a DVD+RW, a compact disc (CD), including a read-only memory (CD-ROM), a CD recordable (CD-R), a CD rewritable (CD-RW), etc., a Blu-ray™ Disc, a magneto-optical disk (MO), a flexible disk (FD), a magnetic tape, a hard disk, a ROM, an electrically erasable programmable read-only memory (EEPROM™), a flash memory, a RAM, a secure digital (SD) memory card, or the like.

The entire or part of the above-mentioned program may be recorded in the above recording medium, to be stored and distributed. Furthermore, the program may be transmitted through communication, for example, a wired network or a wireless communication network used for a local area network (LAN), a metropolitan area network (MAN), a wide area network (WAN), the Internet, an intranet, an extranet, or the like, or a transmission medium of a combination of the above networks. Alternatively, the entire or part of the program may be delivered by carrier waves.

The above-mentioned program may be the entire or part of another program or may be recorded in a recording medium along with a separate program. Further, the program may be divided into multiple recording media and recorded. The program may be recorded in any format, such as compression or encryption, as long as the program may be reproduced.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device comprising:
an acquisition unit that acquires, via a communication line, data of an operating state of an apparatus or a device in accordance with a timing associated with an attribute of the data; and
a display that predicts, based on the data, a state of the apparatus or the device for individual attributes, and displays a request for a visit.

2. The information processing device according to claim 1,
wherein the acquisition unit changes the timing in accordance with a variation amount of data required for prediction.

3. The information processing device according to claim 2,
wherein the acquisition unit changes the timing for each data item.

4. The information processing device according to claim 2,
wherein the acquisition unit changes the timing in a case where there is a change in communication quality of the communication line or accuracy of the prediction.

5. The information processing device according to claim 1,
wherein an image processing apparatus is defined as the apparatus or the device, and
wherein the attributes include one or more of toner, a photoreceptor, a fixing device of the image processing apparatus.

6. The information processing device according to claim 2,
wherein an image processing apparatus is defined as the apparatus or the device, and
wherein the attributes include one or more of toner, a photoreceptor, a fixing device of the image processing apparatus.

7. The information processing device according to claim 3,
wherein an image processing apparatus is defined as the apparatus or the device, and
wherein the attributes include one or more of toner, a photoreceptor, a fixing device of the image processing apparatus.

8. The information processing device according to claim 4,
wherein an image processing apparatus is defined as the apparatus or the device, and
wherein the attributes include one or more of toner, a photoreceptor, a fixing device of the image processing apparatus.

9. A non-transitory computer readable medium storing a program causing a computer to execute a process for information processing, the process comprising:
acquiring, via a communication line, data of an operating state of an apparatus or a device in accordance with a timing associated with an attribute of the data; and
predicting, based on the data, a state of the apparatus or the device for individual attributes, and displaying a request for a visit.
